(19) United States
(12) Patent Application Publication
(10) Pub. No.: US 2007/0009194 A1
(43) Pub. Date: Jan. 11, 2007

(54) Bearing unit for a revolving radial load

(76) Inventor: Johannes Schelbert, Rieneck (DE)

Correspondence Address: Striker Striker Stenby, 103 East Neck Road, Huntington, NY, 11743, US

(21) Appl. No.: 10/569,479

(22) PCT Filed: Jul. 23, 2004
(86) PCT No.: PCT/EP04/08276

§ 371 Date: Feb. 23, 2006

(30) Foreign Application Priority Data
Aug. 29, 2003 (DE) 103-40-261.6

(51) Int. Cl. F16C 43/00

(52) U.S. Cl. 384/537

(57) ABSTRACT

The invention relates to a bearing assembly of a drive shaft, comprising: an anti-friction bearing, which supports the drive shaft in a housing; an inner ring that is fixed to the shaft; and an outer ring that is mounted so that it can slide in relation to the housing. The adjustment between the outer ring and the slide bearing is selected in such a way that the outer ring revolves more slowly than the shaft in relation to the housing when the shaft bearing is subjected to a revolving radial load.

### PRIOR ART

The invention relates to a device for avoiding fretting corrosion and bearing seat deflection in motors in which the motor bearing is subjected to a rotating radial load, e.g. in motors with a rigid clutch.

When installing electric motors in machines, it is possible to use belts, pinions, or clutches to transmit torque, the classic bearing load being a point load. The use of a very rigid clutch generates a rotating radial load. In most cases, the bearing seat represents the primary mechanical “weak point”. The rotating radial load causes the outer race to rotate, resulting in an enlargement of the bearing seat. The removed material, the so-called fretting corrosion, can penetrate into the interior of the bearing, resulting in premature failure of the bearing.

A failure of a single bearing can cause complex production apparatuses, e.g. printing presses, to break down for several hours. Currently, there are only compromise solutions for this specific type of load, e.g. axially clamping the outer race of the bearing or shrink fitting the outer race of the bearing into the bearing fit. Although these solutions do in fact in slightly increase the service life of the components, they do not solve the underlying problem.

The object of the present invention, therefore, is to disclose a device of the type mentioned at the beginning, which minimizes and/or eliminates the mechanical damage to the bearing seat caused by the rotating radial load.

This object is attained by the defining characteristics of the main claim.

The essence of the invention lies in the fact that a journal bearing, which supports a drive shaft in relation to a housing, is supported so that the bearing itself can slide in relation to the housing; in addition, the fit between the outer race and the plain bearing is selected so that, with the rotating radial load of the journal bearing, the outer race is permitted to rotate in relation to the housing at a slower speed than the rotation of the shaft. The combination of the sliding support of the outer race and the fit eliminates the wear on the bearing seat. A clearance fit is provided between the outer race and the plain bearing.

The fit between the outer race and plain bearing is advantageously selected so that the frictional force between the outer race and the plain bearing under the normal operating point load is sufficient to prevent the parts from moving in relation to one another; as a result, under normal operating loads, the bearing behaves like a pure roller bearing. The bearing is thus suitable for use in all conventional applications as well as in specific special applications.

The invention can advantageously be used as a bearing for the output shaft of an electric motor, the plain bearing being mounted in a bearing seat in the motor housing 1. This utilization of the invention means that electric motors can be used as rigidly clutched direct drive units without resulting in premature failure of the bearings.

Another preferred embodiment of the invention is comprised in that the output shaft constitutes the shaft of a housing-free electric motor and the plain bearing is mounted in a bearing seat in the machine into which the motor is incorporated. Consequently, the invention is simultaneously optimized for standard motors and for housing-free motors, which are being used more and more frequently.

In another advantageous embodiment, the journal bearing-is a roller bearing with a sliding outer race that is coated, preferably with Teflon. Consequently, the invention can also be optimized for cases in which there is only a slight amount of radial load or in which the amount of space required must be minimized.

In another advantageous embodiment form, an FG/h clearance fit is provided between the outer race and the plain bearing. This fit permits the required axial movement between the outer race and the plain bearing, but also furnishes the required amount of friction to prevent the rotation of the outer race without rotating radial force.

Through selection of the fits, it has turned out to be advantageous if the ratio of the outer race speed to the shaft speed lies in the range of from 1:1500 to 1:2600. As a result, the surfaces are not unnecessarily worn down, but the damaging rotating radial forces are absorbed.

Exemplary embodiments of the invention will be explained in greater detail below in conjunction with the drawings.

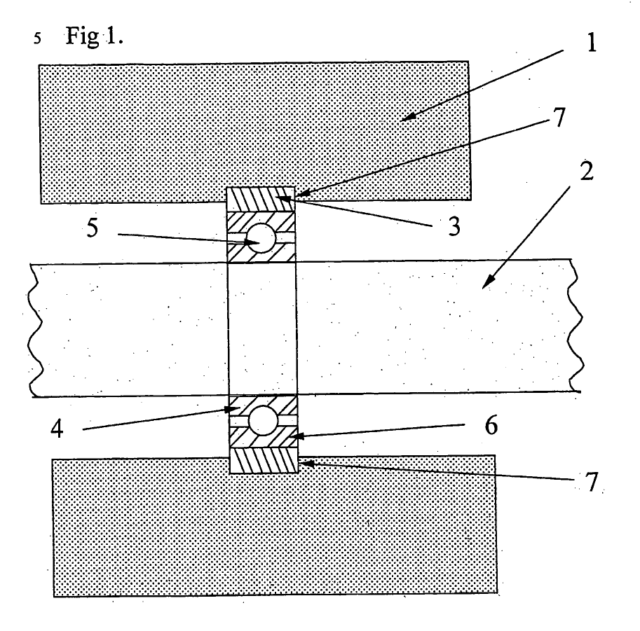

FIG. 1: shows a shaft that is supported according to the invention.

FIG. 1 schematically depicts a drive shaft 2, a bearing comprised of four mechanical components 3, 4, 5, 6, and a housing 1. The bearing 3, 4, 5, 6 supports the shaft 2 and is mounted in a bearing seat 7 in the housing 1. The components 4, 5, and 6 constitute a roller bearing, whose inner race 4 is non-rotatably supported on the shaft 2 and whose outer race 6 is supported so that it can rotate in relation to the housing 1 by means of a plain bearing 3. In order to reduce the friction torque between the outer race 6 and the plain bearing 3 to a minimum, both the outer race 3 of the roller bearing 4, 5, 6 and the plain bearing 3 are coated with a low-friction layer, e.g. a Teflon coating. This double coating, however, is not necessary in most cases.

In applications in which the motor shaft 2 is mechanically connected to the load either directly or by means of a very rigid clutch, it is possible for the load transmitted to the shaft 2 not to be stationary, i.e. in the form of a point, but to instead rotate. The rotating load generates radial forces that must be absorbed by the nearest bearing point. The torque generated by the rotating load is transmitted to the bearing 3, 4, 5, 6 and/or its outer race 6. If the torque exceeds the static friction threshold between the outer race 6 of the roller bearing 4, 5, 6 and the plain bearing 3, then the outer race 6 rotates in relation to the plain bearing 3 and the housing 1.

The absolute speed of the outer race 6 depends directly on the selected fit of the outer race 6/plain bearing 3, i.e. on the air gap between the outer race 6 and the plain bearing 3. The optimum ratio of shaft speed to outer race speed lies in the range between 1500:1 and 2600:1 and corresponds to a fit clearance of between approx. 0.05 and 0.03 mm. With a ratio of 2500:1, a shaft speed of 2500 rpm corresponds to an outer race speed of 1 rpm. This relatively very slow speed is harmless to the plain bearing 3 and the wear on the bearing seat 7 is minimal. If, however, in an extreme case, the coating of the plain bearing 3 were to wear away, the effectiveness of the invention would not impaired significantly because the plain bearing 3 is comprised of bronze and bronze also exhibits low friction when in contact with steel. It would also, of course, be possible to eliminate the plain bearing 3 and use a coated roller bearing 4, 5, 6 with an outer race 6, although this design would be less effective.

The design according to the invention offers the mechanical engineer the advantage that no change needs to be made in the mechanics and offers the motor manufacturer the advantage of using standard components. In addition, no special tools or production processes are required, i.e. additional manufacturing costs are minimal.

What is claimed is:

1. A bearing of an output shaft 2, having a roller bearing 3, 4, 5, 6, which supports the output shaft 2 in a housing 1 and has an inner race 4 affixed to the shaft and an outer race 6,
wherein the outer race 6 of the journal bearing 3, 4, 5, 6 is supported 3 so that it can slide in relation to the housing, the fit between the outer race and the plain bearing 3 being selected so that with a rotating radial load of the journal bearing 3, 4, 5, 6, the outer race 6 is permitted to rotate in relation to the housing 1 at a slower speed than the rotation of the shaft 2.

2. The bearing as recited in claim 1,
wherein the fit is selected so that the frictional force between the outer race 6 and the plain bearing 3 under the normal operating point load is sufficient to prevent the parts from moving in relation to one another.

3. The bearing as recited in claim 1,
wherein with the rotating radial load, the outer race 6 rotates at a speed that is only a fraction of the speed of the output shaft 2.

4. The bearing as recited in claim 2,
wherein the output shaft 2 is the shaft of an electric motor and the plain bearing 3 is mounted in a bearing seat in the motor housing 1.

5. The bearing as recited in claim 2,
wherein the output shaft 2 is the shaft of a housing-free electric motor and the plain bearing 3 is mounted in a bearing seat in the machine into which the motor is incorporated.

6. The bearing as recited in claim 1,
wherein the journal bearing is a roller bearing with a sliding, coated outer race.

7. The bearing as recited in claim 1,
wherein the fit is a clearance fit or its equivalent.

8. The bearing as recited in claim 7,
wherein the fit is an FG/h fit.

9. The bearing as recited in claim 4,
wherein the ratio of the outer race speed (rpm) to the shaft speed (rpm) lies in the range of from 1:1500 to 1:2600.
